(19) United States
(12) Patent Application Publication
(10) Pub. No.: US 2006/0066100 A1
(43) Pub. Date: Mar. 30, 2006

(54) Hose with connector and method for making same

(75) Inventors: Naomi Nakashima, Nishikasugai-gun (JP); Masayuki Taga, Nishikasugai-gun (JP); Norio Watanabe, Nishikasugai-gun (JP); Hiroshi Yamaguchi, Nishikasugai-gun (JP)

Correspondence Address: POSZ LAW GROUP, PLC, 12040 SOUTH LAKES DRIVE, SUITE 101, RESTON, VA, 20191, US

(73) Assignee: c/o TOYODA GOSEI Co., Ltd., Aichi-ken (JP)

(21) Appl. No.: 11/233,370

(22) Filed: Sep. 23, 2005

(30) Foreign Application Priority Data
Sep. 27, 2004 (JP) 2004-278956

(51) Int. Cl. F16L 37/00

(52) U.S. Cl. 285/305

(57) ABSTRACT

A hose and connector of the present invention includes a connector base inserted in an end of a hose. A seal portion is formed at the inside of the connector base. The seal is formed by an elastic material for sealing with a pipe. An outer member is formed at the periphery of the end of the hose, and the outer member encloses the end of the hose and the connector base. A splice combines the seal portion and the outer member, and extends through the hose and the connector base.

### CROSS REFERENCE TO RELATED APPLICATION

This application is based on and incorporates by reference Japanese Patent Application No. 2004-278956, which was filed on Sep. 27, 2004.

### BACKGROUND OF THE INVENTION

The present invention relates to a hose having a connector at an end of the hose. The connector connects a pipe to the hose stably.

The connecting structure between a hose and a pipe is required to have a simple structure. Thus, a quick connector is normally used. U.S. Pat. No. 6,481,758 discloses a hose connector designed to have a seal convexity between a plurality of rings. The rings are inserted inside the hose and swaged to make the seal convexity. The seal convexity is a part of the inner wall of the hose, and forms a seal with the pipe. In order to fix the rings to the inside of the hose, an outer tubular body is applied to the outer periphery of the hose and crimped with the rings by a swaging die.

However, in order to install the connector to the hose, there are many steps, which include laying the outer tubular body on the hose, fixing the rings to the inside of the hose, swaging the outer tubular body and the rings by the swaging die. In other words, the structure of the connector is complicated because rings and the outer tubular body for swaging must be prepared. Also, if high sealing performance is required, more seal convexities are required. In this case, it will be more complicated to install the rings to the inner wall of the hose.

Furthermore, when there are two seal convexities of the hose inner wall, there is a bent ring between two seal convexities. The ring is bent by the swaging die. The curvature of the swaging die must be small because it is difficult to pull out the swaging die from the bent ring after swaging if the swaging die has a large curvature. Therefore, the bent ring has a small curvature and the clearance between two seal convexities is widened. Therefore, when the plurality of the seal convexities is required for obtaining good seal performance, the length of the connector must be long. Thus, the hose cannot be bent near the pipe because the connector is long. Therefore, additional space for connecting the pipe is needed.

### SUMMARY OF THE INVENTION

An object of the invention is to overcome the above-mentioned limitations. The hose with the connector of the present invention has good seal performance while taking relatively little space.

Basically, the hose with the connector of the present invention includes a connector base, which is locatesd in an end of a hose. A seal portion is formed inside of the connector base. An outer member is formed at the periphery of the end of the hose, and the outer member encloses the end of the hose and the connector base. A splice combines the seal portion and the outer member, and the splice extends through the hose and the connector base.

Another aspect of the invention provides a method of manufacturing the above-mentioned hose with the connector. The method includes forming through holes in a hose near one end of the hose, inserting a connector base into the hose, aligning the through holes of the connector base with the through holes of the hose, placing the hose with the connector base between an upper mold part and a lower mold part to make an outer cavity for molding the outer member, aligning the through holes of the hose with gates of the upper and lower mold parts, inserting a core mold into the connector base to make an inner cavity for molding the seal portion, injecting an elastic material into the cavities to join the connector base to the end of the hose to form the connector.

### BRIEF DESCRIPTION OF THE DRAWINGS

The accompanying figures, in which like reference numerals refer to identical or functionally similar elements throughout the separate views and which, together with the detailed description below, are incorporated in and form part of the specification, serve to further illustrate various embodiments and to explain various principles and advantages all in accordance with the present invention.

FIG. 1 shows a perspective view of a hose with connector;

FIG. 2A shows a side view of the hose with connector, and FIG. 2B shows a front view of the hose with connector;

FIG. 3A shows a cross sectional view of the hose with connector, and FIG. 3B shows an enlarged view of a window W of FIG. 3A, and FIG. 3C shows a cross sectional view of a pipe;

FIG. 4 shows a cross sectional view of a connector base;

FIGS. 5A-5C shows process views of widening an end of hose and making through holes on the periphery of the hose;

FIG. 6 shows a cross sectional view of the hose and the connector base set in a mold; and

FIG. 7 shows a cross sectional view of a cavity for making the connector.

### DETAILED DESCRIPTION OF THE PREFERRED EMBODIMENTS

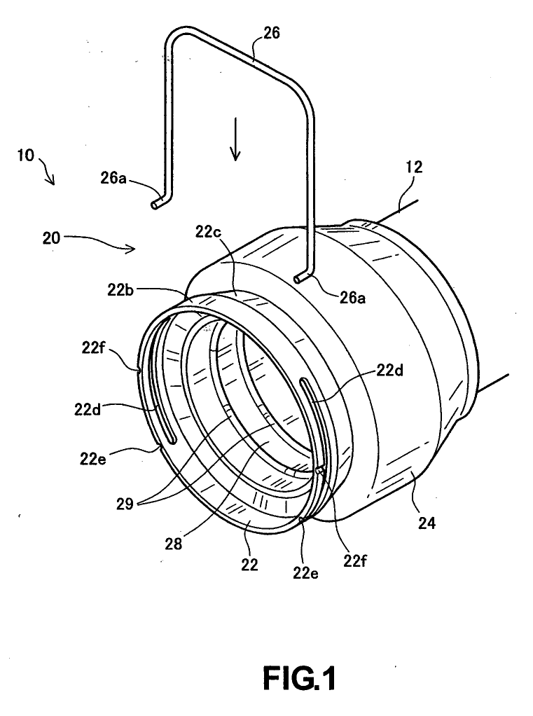

Referring to FIGS. 1-3, a hose connector 10 includes a connector 20 at the end of a hose 12, which is formed by EPDM (ethylene propylene co-polymer rubber) and is reinforced by threads. The connector 20 includes a connector base 22, an outer member 24, which is located on the outer surface of the hose 12 at the end of the hose 12, and a locking clip 26, which prevents a pipe P from escaping from the connector 20.

The connector base 22 is made from a stainless steel pipe. The connector base 22 includes a small opening portion 22a, which is located at an inner end inside of the hose 12, a large opening portion 22b, which is located at an outer end of the hose 12, and a ramp 22c, which connects the small opening portion 22a and the large opening portion 22b. The small opening portion 22a of the connector base 22 surrounds the distal end of the pipe P, which is inserted into the end of the hose 12. The large opening portion 22b of the connector base 22 surrounds a part of the pipe P that is outside of the hose 12.

The large diameter portion 22b includes engaging holes 22d, which engage with the locking clip 26, and two recesses 22e, 22f which lock a hook 26a of the locking clip 26.

The connector 20 includes a seal portion 28 at the inside wall of the small opening portion 22a of the connector base 22. The seal portion 28 is made from an elastic material, for example, one of many kinds of rubber material or thermo plastic elastomer. The seal portion 28 includes two annular bumps 29 on the inside wall thereof. The annular bumps 29 form a seal with the outer surface of the pipe P.

The outer member 24 of the connector 20 surrounds the small opening portion 22a of the connector base 22. The outer member 24 and the seal portion 28 secure the small opening portion 22a to the hose 12, as will be explained in detail below.

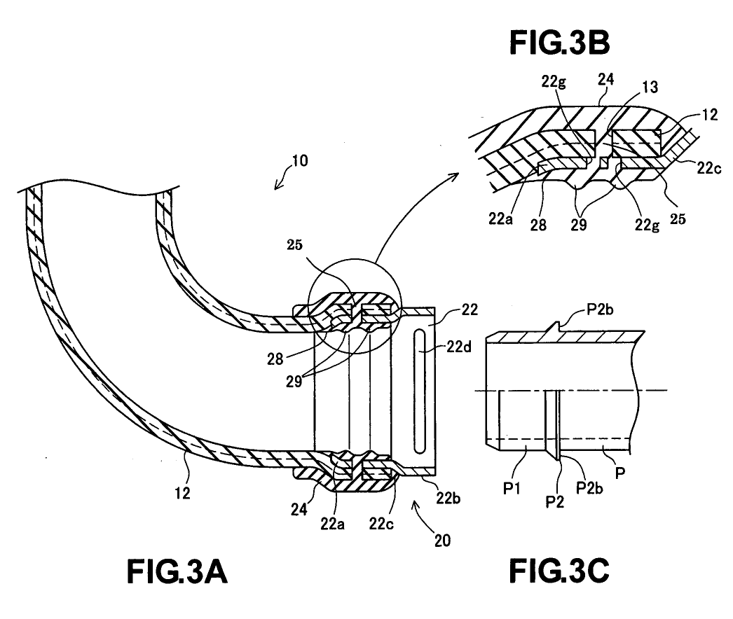

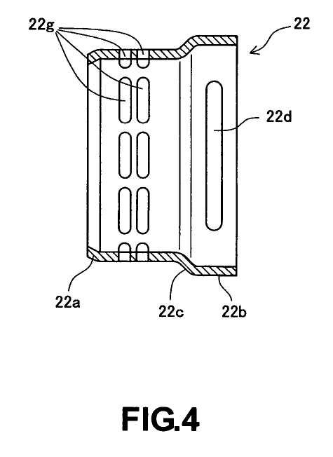

As shown in FIG. 4, the connector base 22 includes through holes 22g, which are formed at even intervals in the wall of the small opening portion 22a. Also, the hose 12 includes hose through holes 13, which align with the through holes 22g of the small opening portion 22a of the connector base 22 (see the enlarged view of FIG.3). In the present embodiment, the outer member 24 and the seal portion 28 are integrally formed by EPDM, which is elastic material for forming a seal. The hose through holes 13 and through holes 22g of the small opening portion 22a are filled with EPDM to form splices 25. The splices 25 are integrally molded with the outer member 24 and the seal portion 28, and combine the outer member 24 and the seal portion 28 into a unitary structure. The outer member 24, the hose 12, the small opening portion 22a and the seal portion 28 are overlapped and layered in this order at the end of the hose 12. Thus, the hose 12 and the small opening portion 22a are integrally held between the outer member 24 and the seal portion 28, and the connector 20 is fixed at the end of the hose 12.

Now the coupling and fixation of the pipe P will be explained. As shown in FIG. 3, an end of the pipe P, which will be referred to as an insert pipe P1, has an annular projection P2 on its periphery. The external diameter of the insert pipe P1 is set so that the annular bump 29 of the seal portion 28 contact the insert pipe P1. In the present embodiment, the external diameter of the insert pipe P is 1 mm larger than the internal diameter of the annular bump 29.

When the pipe P is inserted to the connector 20, the pipe P is surrounded by the large opening portion 22b of the connector base 22, and the annular projection P2 contacts the ramp 22c. Thus, the ramp 22c serves as a stopper.

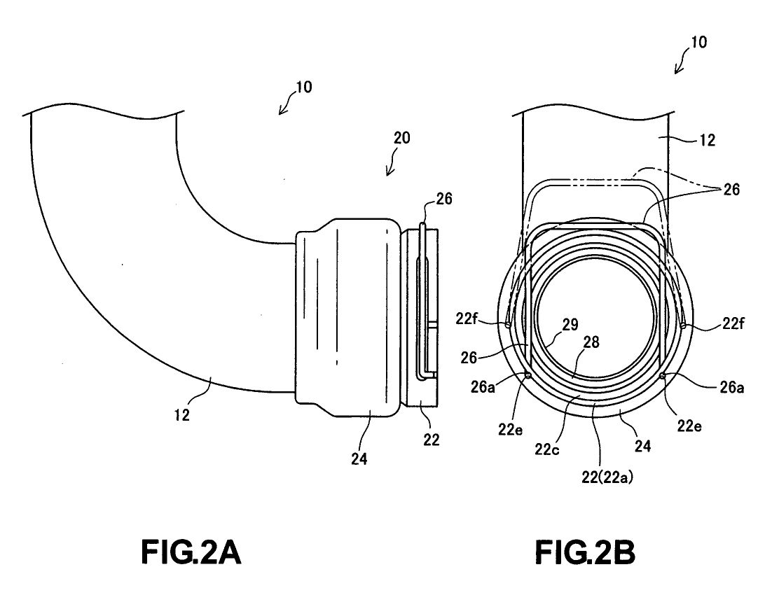

When the pipe P is inserted to the connector 20 and the locking clip 26 is pushed through the engaging holes 22d as shown in FIGS. 1 and 2, the locking clip 26 is locked against a flat backside P2b of the annular projection P2. Thus, the pipe P is locked by the locking clip 26 to the hose 12 at the connector 20.

The hooks 26a of the rocking clip 26 are engaged to the recesses 22e of the large opening portion 22b to maintain the locked state. Also, as shown by two dotted line in FIG. 2A, the hook 26a is separated from the recess 22e when the locking clip 26 is pulled upwardly. Then the locking clip 26 is separated from the engaging hole 22d and released from the pipe P. Thus, the pipe P can be released from the connector 20. When the locking clip 26 is removed, the hook 26a is engaged the recess 22f, which is located above the recess 22e in FIG. 2A.

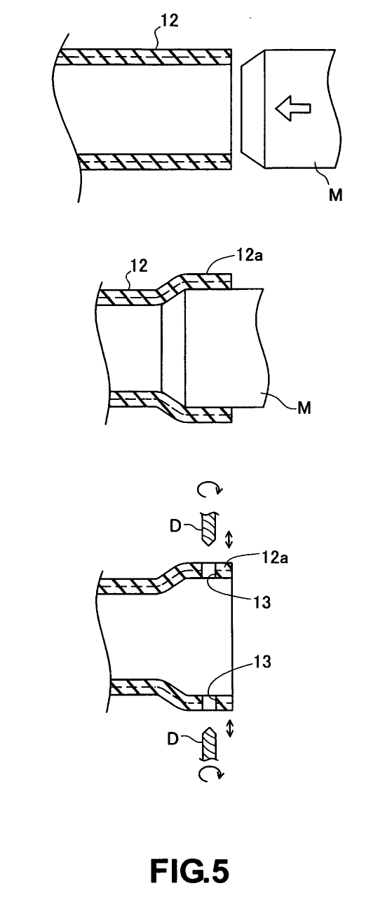

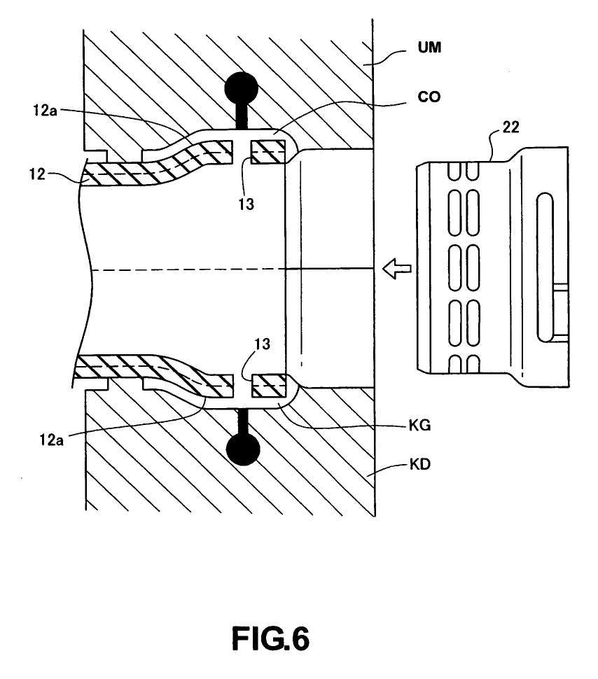

Now a method of manufacturing the hose 12 with the connector 20 will be explained. As shown in FIG. 5A, a mandrel M is inserted to an opening of the hose 12 for expanding the diameter of the hose 12. Then the hose is heated for vulcanizing EPDM. Thus, an expanded portion 12a is formed at the end of the hose 12. The expanded portion 12a is the place where the connector base 22 is set. Then the connector base 22 is inserted to the expanded portion 12a. The hose through holes 13 are formed radially by a drill D or the like at the expanded portion 12a. The hose through holes 13 are aligned with the through holes 22g of the connector base, and these holes serve as a cavity for forming the splices 25. The hose through holes 13 are placed to correspond to gates G of a mold, which is shown in FIG. 6. The hose through holes 13 are formed around the periphery of the expanded portion 12a at even intervals. The outer surface of the expanded portion 12a is preferably disposed roughening treatment to make a patterned indented surface.

After the process on the hose 12, as shown in FIG. 6, the hose 12 is placed in the mold with the connector base 22. The mold includes an upper mold part UM and a lower mold part LM. The upper mold part UM and the lower mold part LM are put together when the hose 12 is placed in the mold. Thus, an outer cavity CO is formed around the expanded portion 12a of the hose 12. The outer cavity CO is for molding the aforementioned outer member 24.

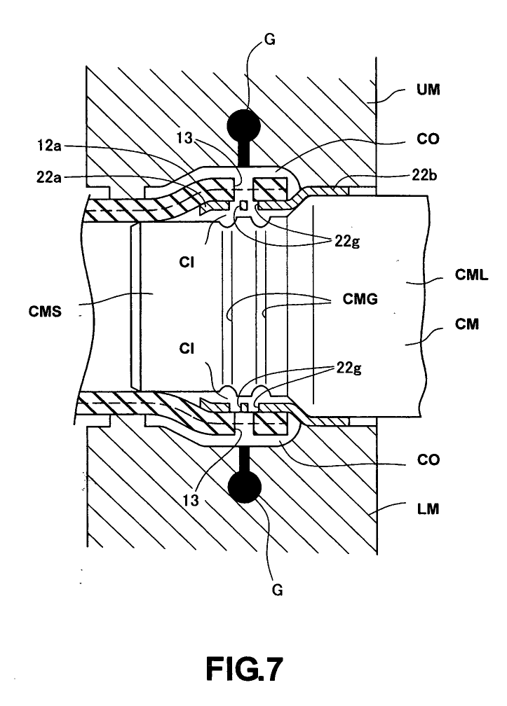

After placing the hose 12 into the mold, the connector base 22 is inserted into the expanded portion 12a and a core mold CM is inserted inside of the connector base 22. The connector base 22 can be inserted into the expanded portion 12a before the hose 12 is placed in the mold. A small diameter portion CMS of the core mold CM contacts an inside wall of the hose 12 and is located beyond the expanded portion 12a as shown in FIG.7. Also, a large diameter portion CML of the core mold CM contacts an inside wall of the large opening portion 22b of the connector base 22. The small diameter portion CMS and the inside wall of the hose 12 contact each other to form a seal, which prevents the hose 12 from changing its shape during the injection process. The core mold CM includes two grooves CMG on the periphery of the small diameter portion CMS. When the core mold CM is set in the mold, as shown in FIG.7, an inner cavity CI is formed at the inside of the small opening portion 22a of the connector base 22. The inner cavity CI forms the seal portion 28, and the grooves CMG are for molding the annular bumps 29. The outer cavity CO and the inner cavity CI communicate with each other through the hose through holes 13 and the through holes 22g.

After injecting EPDM from the gates G of the mold, the outer member 24 is formed in the outer cavity CO, the seal portion 28 is formed in the inner cavity CI, and the annular bumps are formed at the grooves CMG. The hose through holes 13 of the hose 12 and the through holes 22g of the connector base 22 are filled with EPDM, and the splices 25 is formed. Thus, the outer member 24 and the seal portion 28 are integrated by the splices 25. Since the outer surface of the expanded portion 12a is preferably roughened, the outer member 24 is strongly bonded with the expanded portion 12a. After the predetermined time is passed, the upper mold UM and the lower mold LM are separated from the hose 12, and the core mold CM is pulled out from the hose 12. Thus, the hose 12 with connector 20 is completed.

As described above, the position of the two annular bumps 29 is determined by the two grooves CMG of the core mold CM. Therefore, the two annular bumps 29 can be close to one another. Because the seal portion 28 with the annular bumps 29 is integrally formed with the outer member 24, the seal portion 28 and the outer member 24 hold the hose 12 and the small opening portion 22a in between. Therefore there is no need for a fixing process such as a swaging and there is no need for an adhesive agent. As a result, the structure of the connecter 20 is simplified. Also, the connector 20 can be reduced in size because the annular bumps 29 of the seal portion 28 can be put closely.

Moreover, the hose 12 and the connector 20 can be easily manufactured by simple processes, which include expanding the end of the hose 12, forming the hose through holes 13, placing the hose 12 and the connector 20 in the mold, setting the core mold CM, injecting EPDM into the mold.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A connector for connecting a hose with a pipe, comprising:
a connector base, which is located in an end of a hose;
a seal portion formed inside of the connector base;
an outer member formed at the periphery of the end of the hose, wherein the outer member encloses the end of the hose and the connector base; and
at least one splice integrally combining the seal portion and the outer member, wherein the splice extends through the hose and the connector base.

2. A connector according to claim 1, further comprising:
a large opening portion, which has a diameter that is larger than that of the connector base, and the large opening portion surrounds the pipe at the outside of the hose;
a ramp that connects the connector base with the large opening portion, wherein the ramp engages an annular projection of the pipe; and
a locking clip, which is adapted to engage the annular projection of the pipe.

3. A connector according to claim 1, wherein the outer member, the seal portion and the splices form a single member made from the same elastic material.

4. A hose with a connector for connecting with a pipe, comprising:
a hose having an expanded portion at one end, wherein through holes are formed in the expanded portion;
a connector base located in the expanded portion of the hose, wherein the connector base has through holes that correspond to the through holes of the hose;
a seal portion formed inside of the connector base;
an outer member formed at the periphery of the end of the hose, wherein the outer member encloses the expanded portion of the hose and the connector base; and
at least one splice formed at the through holes of the connector base and the through holes of the hose, wherein the splice integrally combines the seal portion and the outer member.

5. A hose with a connector according to claim 4, further comprising:
a large opening portion, which has a diameter that is larger than that of the connector base, and the large opening portion surrounds the pipe at the outside of the hose;
a ramp that connects the connector base with the large opening portion, wherein the ramp engages an annular projection of the pipe; and
a locking clip, which is adapted to engage the annular projection of the pipe.

6. A connector according to claim 4, wherein the outer member, the seal portion and the splices are made from the same elastic material.

7. A method of manufacturing a hose with a connector, comprising:
forming through holes in a hose near one end of the hose;
inserting a connector base, in which includes through holes are formed, into the hose;
aligning the through holes of the connector base with the through holes of the hose, wherein the through holes of the connector base and the through holes of the hose form a cavity for molding splices connecting an outer member and a seal portion;
placing the hose with the connector base between an upper mold part and a lower mold part to make an outer cavity for molding the outer member;
aligning the through holes of the hose with gate of the upper and lower mold parts;
inserting a core mold, which includes at least one groove around the core mold, into the connector base to make an inner cavity for molding the seal portion, and the inner cavity communicates the outer cavity through the through holes of the connector base and the through holes of the hose;
injecting an elastic material into the cavities to join the connector base to the end of the hose to form the connector;
removing the hose with the connector from the molds.

8. A method of manufacturing a hose with a connector according to claim 7, further comprising
roughening an outer surface of the hose before injecting the elastic material.

9. A method of manufacturing a hose with a connector, comprising:
inserting a mandrel into an opening of a hose for expanding the diameter of the hose;
vulcanizing the hose with the mandrel;
removing the mandrel from the hose;
forming through holes in the expanded portion of the hose;
inserting a connector base, in which includes through holes are formed, into the hose;
aligning the through holes of the connector base with the through holes of the hose, wherein the through holes of the connector base and the through holes of the hose form a cavity for molding a splice between an outer member and a seal portion;
placing the hose with the connector base between an upper mold part and a lower mold part to make an outer cavity for molding the outer member;
aligning the through holes of the hose with gates of the upper and lower mold parts;
inserting a core mold, which includes at least one groove around the core mold, into the connector base to make an inner cavity for molding the seal portion, and the inner cavity communicates with the outer cavity through the through holes of the connector base and the through holes of the hose;
injecting an elastic material into the cavities to join the connector base to the end of the hose to form the connector;
removing the hose with the connector from the molds.

10. A method of manufacturing a hose with a connector according to claim 9, further comprising
roughening an outer surface of the expanded portion of the hose before injecting the elastic material.
